(19) United States
(12) Patent Application Publication
(10) Pub. No.: US 2012/0017937 A1
(43) Pub. Date: Jan. 26, 2012

(54) CLEANING KIT AND METHOD

(75) Inventor: Milind B. Sabade, Woodbury, MN (US)

(73) Assignee: 3M Innovative Properties Company

(21) Appl. No.: 13/112,239

(22) Filed: May 20, 2011

Related U.S. Application Data
(60) Provisional application No. 61/346,962, filed on May 21, 2010.

(51) Int. Cl. B08B 1/00; B65D 71/00

(52) U.S. Cl. 134/6; 206/229

(57) ABSTRACT

A cleaning kit for cleaning and polishing a surface includes a scouring pad, a degreaser, a cleaner/polish, a microfiber cleaning cloth, and a container. A method of cleaning a metal surface includes the steps of providing a cleaning kit including a degreaser comprising surfactant, emulsifier and solvent, a scouring pad comprising coiled fibers, a cleaner/polish comprising solvent and surfactant, a microfiber cleaning cloth, and a container, and then applying the degreaser to the metal surface, scrubbing the metal surface with the scouring pad, wiping the metal surface with a microfiber cleaning cloth, applying the cleaner/polish to the metal surface, and wiping the metal surface with a microfiber cloth.

### CROSS REFERENCE TO RELATED APPLICATION

This application claims the benefit of U.S. Provisional Patent Application No. 61/346,962, filed May 21, 2010, the disclosure of which is incorporated by reference herein in its entirety.

### BACKGROUND

The present invention relates generally to cleaning and, more particularly, to a kit and method for cleaning a hard surface such as a stainless steel surface.

It is often necessary to remove contaminants, such as dirt, dust, and grease, from a surface. With certain surfaces, it is often desirable to clean the surface so it has a shiny, glossy or polished appearance.

### SUMMARY

The ability to effectively clean a surface depends on a variety of factors including the nature of the surface being cleaned (e.g. the type of material, such as fabric, wood, metal, glass, or plastic, and whether the surface has a textured or smooth surface), and further depends on the nature of the material being removed from the surface (e.g. dust, gum, adhesive, permanent marker, oil). The need exists for a way to thoroughly and conveniently clean a surface. A particular need exists for a way to effectively clean a hard surface, such as a metal surface, which has been soiled with oily or greasy substances, and which is intended to have a shiny appearance.

It would be desirable to provide a way to thoroughly and conveniently clean a surface, such as a hard surface meant to have a shiny and or glossy appearance, and particularly including relatively large (e.g. having a surface area of at least about one square foot) flat metal surfaces, such as metal wall surfaces, that are prone to accumulating greasy or oily substances. The present invention provides a kit and a method that can be used to thoroughly and conveniently clean such a surface.

In one embodiment, the present invention provides a cleaning kit for cleaning and polishing a metal surface. The cleaning kit comprises a scouring pad, a degreaser, a cleaner/polish, a microfiber cleaning cloth, and a container. The cleaning kit may optionally include a tool or handle device. The handle device may include an attachment surface that allows the scouring pad to be removably attached to the handle device. The attachment surface may include, for example, an adhesive or a refastenable mechanical attachment, such as a hook-and-loop type fastener.

The scouring pad may comprise a nonwoven pad. The nonwoven pad may generally include fibers, and, optionally, scouring particles bonded to the fibers with a resin. In one embodiment, the fibers may be crimped and heat set. In another embodiment, the fibers may have a denier of no greater than about 250. In one aspect, the fibers may be formed of a polymeric material. In another embodiment, the nonwoven scouring pad may comprise coiled nonwoven fibers having a diameter of at least about 8 mils. In a specific embodiment, the coiled nonwoven fibers may be formed of nylon. The scouring particles may comprise organic polymeric material. The scouring particles may include, for example, aluminum oxide, silicon carbide, aluminum silicate, calcium carbonate, melamine formaldehyde resin particles, and combinations and mixtures thereof. In a specific aspect, the scouring particles may have a size of about 400 to about 450 microns. The resin used to bind the scouring particles to the fibers may comprise a phenolic resin, polyurethane, styrene butadiene rubber, and combinations and mixtures thereof.

The degreaser may comprise surfactant, emulsifier, and solvent. In a specific aspect, the degreaser may include between about 30 percent and about 50 percent by weight surfactant, between about 25 percent and 35 percent by weight emulsifier, between about 15 percent and about 25 percent by weight water, and between about 5 percent and 15 percent by weight solvent.

The cleaner/polish may be provided as a liquid, a paste, or an aerosol. The cleaner/polish may include solvent and surfactant. In a specific aspect, the cleaner/polish may include between about 50 percent and about 70 percent by weight water, between about 15 percent and 25 percent by weight mineral oil, between about 5 percent and 15 percent by weight mineral spirit, and between about 3 percent and about 5 percent by weight surfactant.

The microfiber cleaning cloth may be a woven material, such as a knitted material, which may have a textured surface having a three-dimensional surface topography. The textured surface may include, for example, raised regions (e.g. tufts), and recessed regions (e.g. valleys). In a specific aspect, the microfiber cleaning cloth may comprise bi-component microfibers having a denier of less than one. The bi-component fibers may be formed of, for example, polyester and nylon.

In another aspect, the present invention provides a method of cleaning a metal surface, particularly a generally flat metal surface soiled with an oily or greasy substance. The method includes the first step of providing a cleaning kit including a degreaser—which may comprise surfactant, emulsifier and solvent, a scouring pad—which may comprise coiled fibers, a cleaner/polish—which may comprise solvent and surfactant, a microfiber cleaning cloth, and a container. The degreaser is first applied to the metal surface, and the metal surface is scrubbed using the scouring pad. The metal surface is then wiped clean using a microfiber cleaning cloth. Last, the cleaner/polish is applied to the metal surface, and the metal surface is once again wiped clean using a microfiber cloth. The method may be used to clean a variety of hard surfaces including metal surfaces formed of, for example, stainless steel, aluminum, chrome, and brass.

An advantage of certain embodiments of the invention include that it provides a convenient way to effectively clean a hard surface, particularly relatively large flat surfaces that are generally intended to have a shiny or glossy appearance, and that are subject to the accumulation of oily or greasy substances.

### BRIEF DESCRIPTION OF THE DRAWING

The present invention will be further described with reference to the accompanying drawing, in which:

FIG. 1 is a cleaning kit according to the invention.

### DETAILED DESCRIPTION

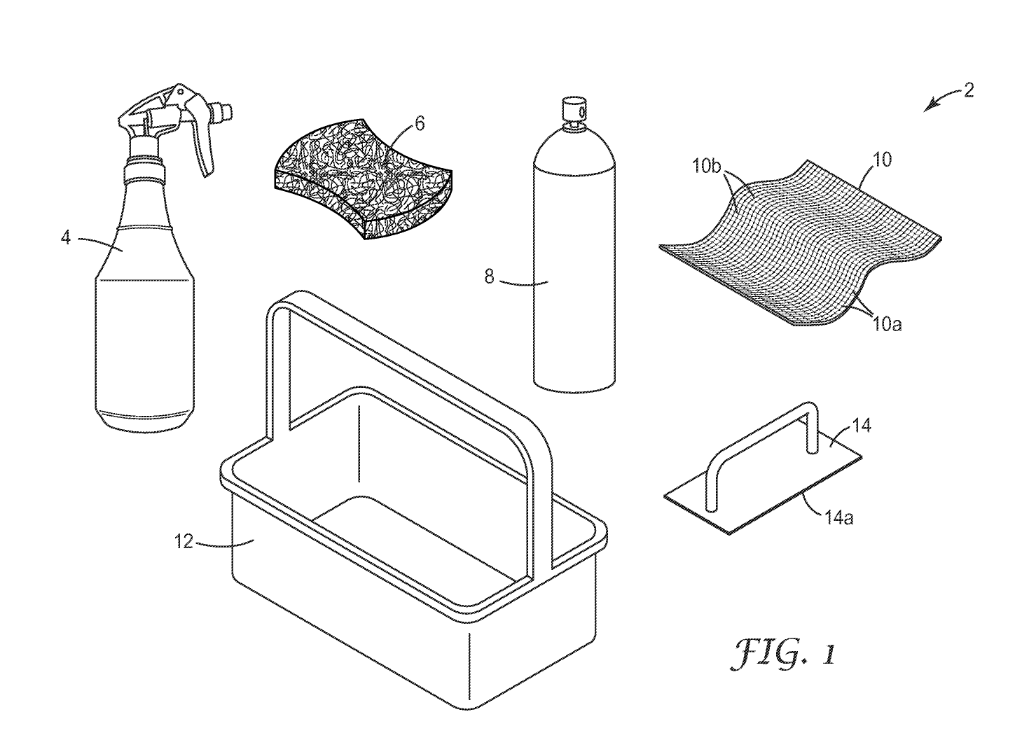

Referring now to the drawing, FIG. 1 shows a cleaning kit 2 for cleaning and polishing a metal surface (not shown). The cleaning kit 2 generally includes a degreaser 4, a scouring pad 6, a cleaner/polish 8, at least one microfiber cleaning cloth 10, and a container 12 for storing and transporting the cleaning and polishing items. In the illustrated embodiment, the cleaning kit 2 includes an optional tool or handle device 14 that can be used in conjunction with the scouring pad 6 or microfiber cleaning cloth 10. Each of the individual components of cleaning kit 2 is described in greater detail below.

In accordance with one aspect, the cleaning kit 2 includes a general purpose degreaser 4 formulated to loosen and/or remove oily substances from the metal surface being cleaned. The particular degreaser is not significant to the invention hereof, so long as it provides the desired function of loosening and/or removing greasy or oily substances from the metal surface being cleaned. Suitable degreasing formulations generally comprise a surfactant. Additional ingredients in the degreaser 4 may include emulsifiers and solvents.

In a more specific embodiment, the degreaser 4 may comprise between about 30 percent and about 50 percent by weight surfactant, between about 25 percent and 35 percent by weight emulsifier, between about 15 percent and about 25 percent by weight water, and between about 5 percent and 15 percent by weight solvent. Suitable commercially available general purpose degreasers include, for example, 3M Food Service Degreaser (Twist 'n Fill # 7 H) and 3M Industrial Degreaser (Twist 'n Fill #26 L) available from 3M Company, St. Paul, Minn.

In accordance with another aspect, the cleaning kit 2 includes a scouring pad 6. The scouring pad 6 may be formed of, for example, a nonwoven material. The particular scouring pad 6 is not significant to the invention hereof, so long as it allows a user to scrub the surface, and thereby loosen and/or remove unwanted material from the surface. In one desirable aspect, the scouring pad 6 can be used to remove dirt, grease, and the like from the surface without scratching or otherwise damaging the surface. In another aspect, the scouring pad 6 provides a polishing action that removes or reduces the appearance of blemishes or minor surface imperfections, such as fine scratches, from the surface.

In one aspect, the scouring pad 2 may comprise a fibrous nonwoven web. The nonwoven web may comprise fibers formed of a polymeric material such as, for example, polyester and/or nylon. To improve the durability of the nonwoven web, the fibers may be crimped and heat set. In a specific aspect, the fibers have a denier of no greater than about 250.

In another aspect, the scouring pad 2 may include scouring particles (e.g. mineral). Scouring particles may be included in the scouring pad to increase the scouring action of the pad depending on the needs of a particular end use application. Suitable scouring particles include, for example, aluminum oxide, silicon carbide, aluminum silicate, calcium carbonate, melamine formaldehyde resin particles, and combinations and mixtures thereof. The scouring particles generally have a size of less than about 450 microns, or less than about 40 grit. The scouring particles may be bonded to the fibers with a binder or resin such as, for example, a phenolic resin, polyurethane, or styrene butadiene rubber.

In another aspect, the nonwoven scouring pad comprises coiled fibers. Such fibers typically have a diameter of at least about 8 mils. The coiled fibers may be formed of a polymeric material such as, for example, nylon. Nonwoven webs formed of coiled fibers are generally more open than nonwoven webs formed of small denier fibers. This allows dirt and debris entrapped in a coiled fiber web to be more easily removed by rinsing.

Suitable scouring pads are described in, for example, U.S. Patent Publication No. 2009/0038102, and U.S. patent application Ser. No. 12/421,753, U.S. patent application Ser. No. 12/653,557, and U.S. patent application Ser. No. 12/639,217.

Suitable commercially available scouring pads include 3M General Purpose Scour Pad No. 96 SB, 3M Heavy Duty Scour Pad No. 86 SB, 3M Extra Heavy Duty Pot'n Pan Scour Pad, 3M Purple Scour Pad No. 2020 SB, and 3M Power Pad No. 2000 SB, each available from 3M Company, St. Paul, Minn.

The cleaning kit also includes a cleaner/polish 8. The particular cleaner/polish is not significant to the invention hereof, so long as it wipes clean, thereby leaving the surface with a shiny or glossy-like appearance free of streaks, smudges, and smears. The cleaner/polish may be provided, for example, as a paste, a liquid or as an aerosol. Suitable cleaner/polish formulations generally include solvent and surfactant. In a more specific aspect, the cleaner/polish may include between about 50 percent and about 70 percent by weight water, between about 15 percent and 25 percent by weight mineral oil, between about 5 percent and 15 percent by weight mineral spirit, and between about 3 percent and about 5 percent by weight surfactant.

Suitable cleaner/polishes include, for example, 3M Stainless Steel Cleaner and Polish available from 3M Company, St. Paul, Minn. in both aerosol and liquid forms.

The cleaning kit 2 also includes a microfiber cleaning cloth 10. The particular cleaning cloth is not significant to the invention hereof, so long as it is compatible with the degreaser and cleaner/polish, does not scratch the surface being cleaned, and leaves the surface substantially free of lint or dust. In one aspect, the microfiber cleaning cloth 10 includes a textured surface having raised tufted regions 10a separated by recessed regions 10b. In a desirable aspect, the cleaning cloth 10 may be a woven material, such as a knitted material.

Microfiber cleaning cloths 10 generally comprise synthetic fibers having a denier of less than about one. The fibers may be bi-component or bi-constituent fibers formed by extruding two different polymers through the same orifice. The fibers may be formed of, for example, polyester, polyamide (e.g. nylon), or other polymers. In a specific construction, the microfiber cloth 10 may include fibers formed of polyester and nylon.

A suitable commercially available microfiber cleaning cloth is the Scotch-Brite High Performance Cloth No. 2011 available from 3M Company, St. Paul, Minn.

The cleaning kit 2 also includes a container 12. The particular container is not significant to the invention hereof, so long as it may be used to, for example, store or transport the degreaser 4, scouring pad 6, cleaner/polish 8, and microfiber cleaning cloth 10. The container 12 may be, for example, a caddy, bucket, box, bag, tote, case or other type of vessel.

The cleaning kit 2 may also include an optional tool or handle device 14. The handle device 14 is provided to be used in conjunction with the scouring pad 6. Use of a handle device 14 reduces fatigue, and allows a user to more readily apply the scrubbing force required to effectively clean a surface. The handle device 14 comprises an attachment surface 14a to which the scouring pad 6 may be removably attached. The attachment surface may comprise, for example, adhesive or a refastenable mechanical attachment mechanism such as a hook-and-loop attachment system.

A suitable handle is the handle provided with the Scotch-Brite Scotchbrick Griddle Scrubber, available from 3M Company, St. Paul, Minn., which product also includes a nonwoven scrubbing pad.

In accordance with another aspect, a metal surface may be cleaned and polished by spraying or otherwise applying degreaser to the metal surface. The degreaser may be a general purpose degreaser comprising, for example, surfactant, emulsifier, and solvent. Next, the metal surface is scrubbed using a scouring pad to loosen and remove dirt, grease, and other contaminants from the surface. The scouring pad may comprise, for example, a nonwoven scrubbing pad including coiled nonwoven fibers, and may be used with or without the aid of a handle device. For added scouring action, the scouring pad may include scouring particles. Once the metal surface has been scrubbed, it is wiped clean using a microfiber cloth. A cleaner/polishing solution is then sprayed or otherwise applied to the metal surface. The cleaner/polishing solution may comprise, for example, solvent and surfactant. To complete the cleaning process, the metal surface is once again wiped clean using a microfiber cloth. It will be recognized that this cleaning technique may be used to clean a variety of metal surfaces including, for example, stainless steel, aluminum, chrome, and brass.

Persons of ordinary skill in the art may appreciate that various changes and modifications may be made to the invention described above without deviating from the inventive concept. Thus, the scope of the present invention should not be limited to the structures described in this application, but only by the structures described by the language of the claims and the equivalents of those structures

What is claimed is:

1. A cleaning kit for cleaning and polishing a metal surface, comprising:
(a) a scouring pad;
(b) a degreaser;
(c) a cleaner/polish;
(d) a microfiber cleaning cloth; and
(e) a container.

2. A cleaning kit as defined in claim 1, further comprising a handle device.

3. A cleaning kit as defined in claim 2, wherein the handle device comprises an attachment surface for removably attaching the scouring pad.

4. A cleaning kit as defined in claim 3, wherein the attachment surface comprises at least one of an adhesive and a refastenable mechanical attachment mechanism.

5. A cleaning kit as defined in claim 1, wherein the scouring pad comprises a nonwoven pad.

6. A cleaning kit as defined in claim 5, wherein the nonwoven scouring pad includes fibers, scouring particles and resin.

7. A cleaning kit as defined in claim 6, wherein the fibers are crimped and heat set.

8. A cleaning kit as defined in claim 7, wherein the fibers have a denier no greater than about 250.

9. A cleaning kit as defined in claim 8, wherein the nonwoven scouring pad comprises coiled nonwoven fibers having a diameter of at least about 8 mils.

10. A cleaning kit as defined in claim 9, wherein the coiled nonwoven fibers are formed of nylon.

11. A cleaning kit as defined in claim 6, wherein the scouring particles comprise organic polymeric material.

12. A cleaning kit as defined in claim 11, wherein the scouring particles include aluminum oxide, silicon carbide, aluminum silicate, calcium carbonate, melamine formaldehyde resin particles, and combinations and mixtures thereof.

13. A cleaning kit as defined in claim 12, wherein the scouring particles have a size of about 400 to about 450 microns.

14. A cleaning kit as defined in claim 1, wherein the resin comprises at least one of a phenolic resin, polyurethane, styrene butadiene rubber, and mixtures thereof.

15. A cleaning kit as defined in claim 1, wherein the cleaner/polish comprises solvent and surfactant.

16. A cleaning kit as defined in claim 15, wherein the cleaner/polish comprises:
(a) between about 50 percent and about 70 percent by weight water;
(b) between about 15 percent and 25 percent by weight mineral oil;
(c) between about 5 percent and 15 percent by weight mineral spirit; and
(d) between about 3 percent and about 5 percent by weight surfactant.

17. A cleaning kit as defined in claim 1, wherein the degreaser comprises surfactant, emulsifier, and solvent.

18. A cleaning kit as defined in claim 17, wherein the degreaser comprises:
(a) between about 30 percent and about 50 percent by weight surfactant;
(b) between about 25 percent and 35 percent by weight emulsifier;
(c) between about 15 percent and about 25 percent by weight water; and
(d) between about 5 percent and 15 percent by weight solvent.

19. A cleaning kit as defined in claim 1, wherein the microfiber cleaning cloth comprises bi-component microfibers having a denier of less than one.

20. A cleaning kit as defined in claim 19, wherein the microfiber cleaning cloth comprises fibers formed of polyester and nylon.

21. A method of cleaning a metal surface, comprising the steps of:
(a) providing a cleaning kit including a degreaser comprising surfactant, emulsifier and solvent, a scouring pad comprising coiled fibers, a cleaner/polish comprising solvent and surfactant, a microfiber cleaning cloth, and a container;
(b) applying the degreaser to the metal surface;
(c) scrubbing the metal surface with the scouring pad;
(d) wiping the metal surface with a microfiber cleaning cloth;
(e) applying the cleaner/polish to the metal surface; and
(f) wiping the metal surface with a microfiber cloth.
